(19) United States
(12) Patent Application Publication
(10) Pub. No.: US 2004/0119822 A1
(43) Pub. Date: Jun. 24, 2004

(54) Multiple camera system on single monitor display

(76) Inventors: Robert J. Custer, Westlake, OH (US); Mark A. Matko, North Olmstead, OH (US); Mark Waltz, Broadview Heights, OH (US)

Correspondence Address: CALFEE HALTER & GRISWOLD, LLP, 800 SUPERIOR AVENUE, SUITE 1400, CLEVELAND, OH, 44114, US

(21) Appl. No.: 10/325,083

(22) Filed: Dec. 20, 2002

(51) Int. Cl. H04N 7/18

(52) U.S. Cl. 348/148; 348/143

(57) ABSTRACT

A monitor system used on a vehicle for displaying multiple video signals simultaneous on a single monitor screen. The system includes cameras, video instrumentation amplifiers, video image processors, and monitors for displaying separate or combined camera views.

### FIELD OF THE INVENTION

The present invention is related to a camera system for combining multiple video signals into one signal, and specifically, a monitor control system for displaying multiple video signals simultaneously on a single screen for use in a vehicle.

### BACKGROUND OF THE INVENTION

Camera monitors are generally adapted to receive only one video signal at a time from one or more cameras. An operator is able to select the specific camera view with a controller and alternate between each view. However, the process of going through all the views in order to select the best view under the circumstances is very time consuming. In addition, the operator may desire to watch multiple views simultaneously.

Further, a common safety driving practice is to remain several car lengths behind a tractor trailer in order for the truck driver to use his side view mirrors to monitor the whereabouts of the following vehicle. However, not all vehicles follow this safety practice. A commercial truck is not able to use a rearview mirror to see behind the trailer, and side view mirrors are not able to reflect what is directly behind the trailer. It would be beneficial for a driver of a vehicle to be able to see all around his vehicle without having to take his eyes off the road in front of the vehicle.

Accordingly, the need exists to select and display either a single image or multiple images to be shown on one screen.

### SUMMARY OF THE INVENTION

The present invention is a monitor control system used on a vehicle for displaying multiple video sources on a single screen or multiple screens. The system includes cameras for outputting video signals, a video instrumentation amplifier connected to each camera for amplifying signals outputted by the cameras, at least one monitor for receiving signals outputted by the cameras and for visually displaying the signals as images on the screen, and a video image processor connected to each monitor and video instrumentation amplifier for receiving the amplified signals from the video instrumentation amplifier for selecting the desired signal to be displayed on the monitor.

In addition, the present invention is a method of displaying a single image or multiple images from a camera on one screen. The method includes generating separate video signals from more than one camera, converting and amplifying the separate video signals for compatibility with a video image processor, and combining all separate video signals into a single standard video output signal.

### BRIEF DESCRIPTION OF THE DRAWINGS

FIG. 1 shows a schematic of an exemplary embodiment in accordance with the present invention.

FIG. 2 shows a schematic of an additional exemplary embodiment in accordance with the present invention.

FIG. 3 shows a flowchart of an exemplary embodiment in accordance with the present invention.

FIG. 4 shows an exemplary embodiment of the present invention with exemplary positioning of cameras around a commercial vehicle.

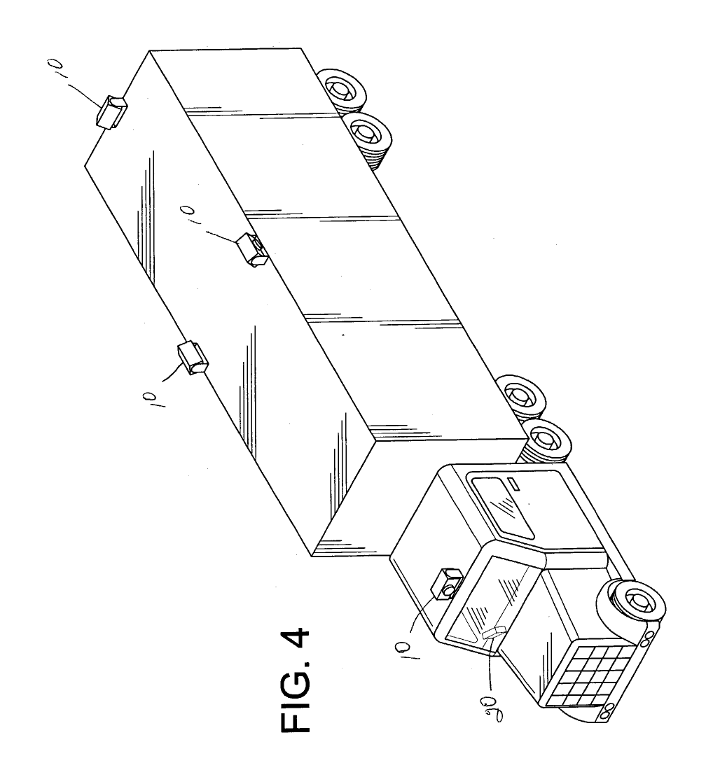

### DETAILED DESCRIPTION OF THE INVENTION

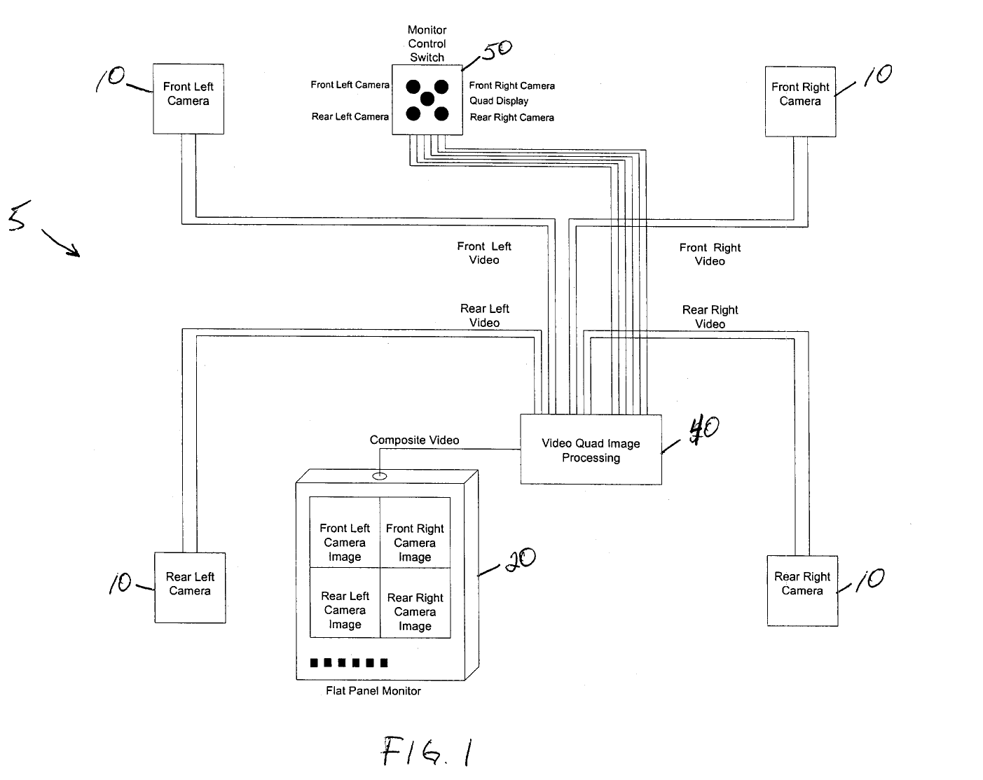

The present invention is a monitor control system for displaying images from multiple video sources on a single screen. The system is adaptable to display either separate video signals or combined video signals on a display unit with a single monitor screen as illustrated in the diagram of the preferred embodiment. As shown in the preferred embodiment of FIG. 1, a four camera vision system 5 includes a display unit or monitor 20, a video image processor 40, and cameras 10.

In the preferred embodiment, the cameras 10, for example infrared cameras, security cameras, video cameras, CCD or CMOS digital cameras, etc., are used on a vehicle for generating video signals to the display unit 20 for a driver or passenger of the vehicle to view. Generally, the cameras 10 are mounted on the exterior of the vehicle to assist the vehicle driver in increasing his vision during nighttime driving, to provide surveillance, or to assist the driver in viewing behind the vehicle, such as a commercial truck with a trailer. In addition, the present invention may be used on military vehicles, such as tanks.

The camera outputs the video signals to a video image processor 40, as known in the art, for combining at least two, preferable four, received signals into a single standard video output signal. The processor is a system of electronic components that electrically switch inputs or disassembles multiple standard video signals and combines multiple video signals into a single standard video output signal to form multiple images on a single monitor screen.

In addition, a controller 50 is connected with the video image processor 40. In the preferred embodiment, the controller is composed of a set of five electro-mechanical push-button operator selector multi-pole switches. The multi-pole switch has a normally open and a normally closed set of contacts. The controller 50 closes electrical contact when an operator pushes the button for the position of the desired image. The normally open set of contacts is used for the switching function. The controller 50 selects the signal to be outputted from the video image processor 40. The video image processor can either output a separate signal from the selected camera view or output the single standard video output signal showing all camera views. However, other embodiments of the controller may be used with the monitor control system, which are, but not limited to, a single switch controller with different positions for the different camera views, including a position for the multi-view, a joystick, a touch screen, and a wireless remote controller.

The signal selected to be outputted from the video processor is shown on a display unit or monitor 20. The monitor 20 is preferably located in front of the driver of the vehicle or a passenger such as, but not limited to, on the dashboard of the vehicle. Displayed on the monitor 20 will be either one selected camera view or the combined camera views, preferably four different views. However, two or three different views may be displayed with the video image processor combining the video signals into one standard signal. The display unit or monitor for the present invention is preferably a flat panel screen such as, for example, a television monitor, a computer monitor, but may also be, but not limited to, a liquid crystal display (LCD), a heads up/down display (HUD, HDD), personal digital assistant (PDA) or a laptop computer.

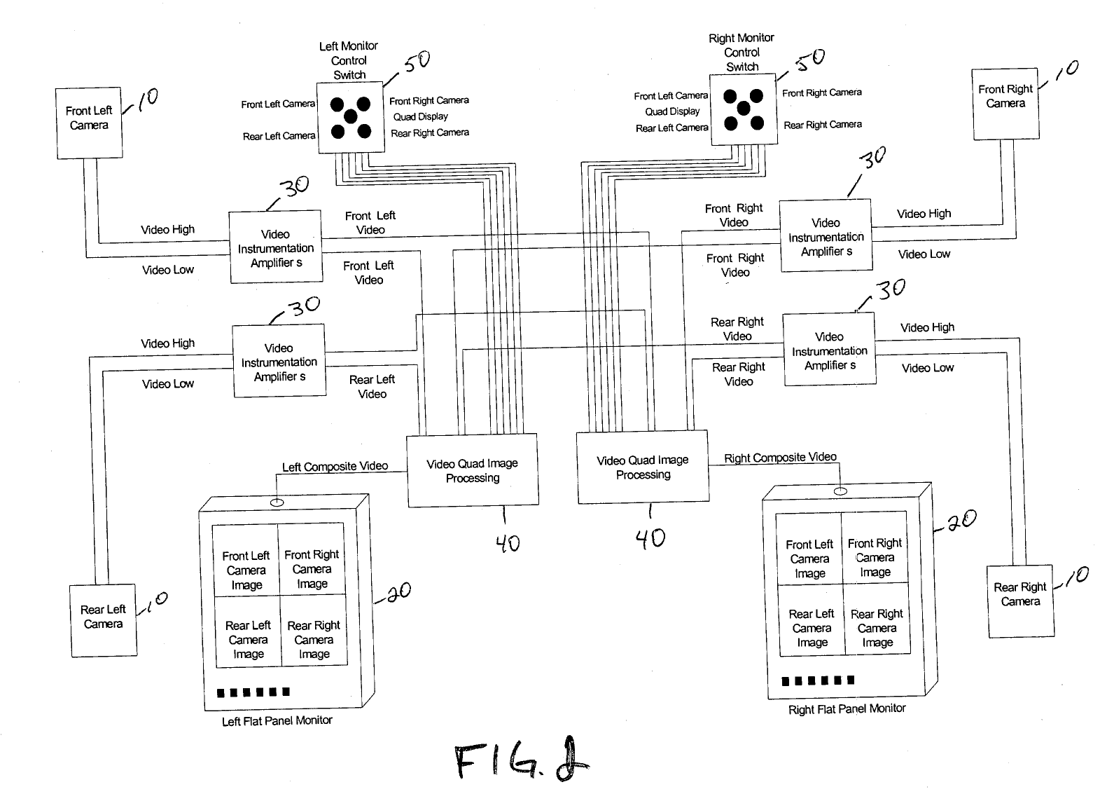

An alternative embodiment, shown in FIG. 2, of the monitor control system for displaying multiple video signals on a single screen is to include additional monitors 20. Each monitor 20 is connected to a separate video image processor 40. One controller 50 can be used for more than one monitor 20 or separate controllers 50 for each monitor 20 can also be used. An additional monitor 20 are beneficial for more than one operator to have control over which camera view should appear on the monitor. Another benefit of more than one monitor is that additional monitors 20 can be placed in more than one location for convenience or necessity, such as for surveillance.

For the multiple monitor system shown in FIG. 2, video signals from each camera are first sent to video instrumentation amplifiers 30, as known in the art, for amplifying the video signal. The amplifier is a system of electronic components that amplify an electrical signal's amplitude. The video instrumentation amplifier 30 first converts the video signal from the visible light or infrared camera 10 which has a differential signal type to a single ended signal referenced to power ground for compatibility with other electrical instruments. Secondly, it is able to drive multiple signal receivers from a single source without signal loss. Though a video instrumentation amplifier 30 is not required for a single monitor system, the amplifier 30 may be used in the system.

A further alternative embodiment may include a monitor 20 with a built in controller 50, or a built in touch screen monitor, rather than a separate controller, for selecting the view displayed.

Another embodiment of the monitor control system is for wireless transmission from the cameras 10 to a wireless receiver on the video image processor 40. This allows for convenient installation of the system, especially on the trailer of a commercial truck.

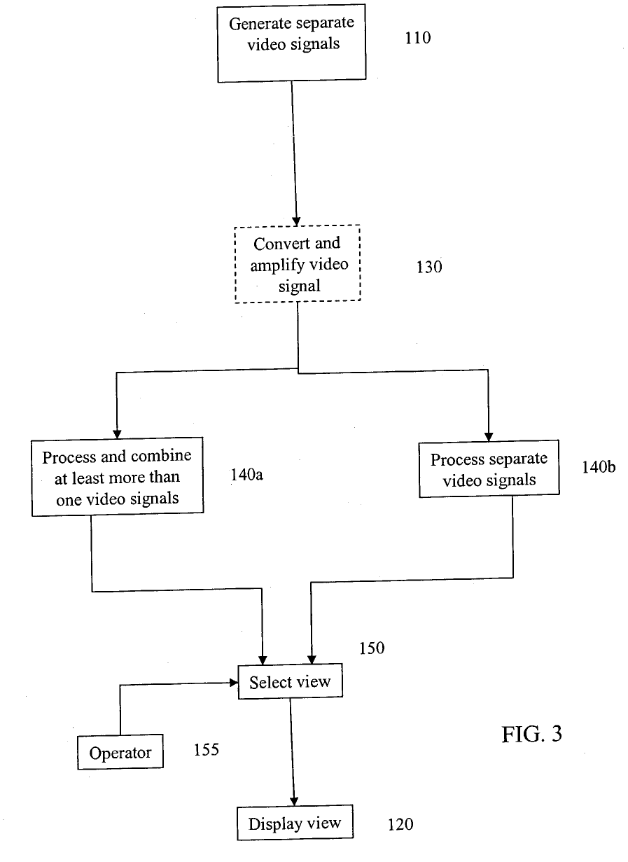

As shown in FIG. 3, the system works by generating separate video signals 110 from each camera 10 in the system. If in the multiple monitor system, then the video signals are converted and amplified 130 by the video instrumentation amplifier 30 before being outputted to the video image processor 40. Separate video signals are combined 140a into one single video signal or processed and maintained as a separate signal 140b by the video image processor 40. An operator 155 uses the controller 50 to select 150 either a separate signal or the combined signal for displaying 120 on the monitor 20.

The foregoing description is, at present, considered to be preferred embodiments of the present invention. However, it is contemplated that various changes and modifications apparent to those skilled in the art may be made without departing from the present invention. Therefore, the foregoing description is intended to cover all such changes and modifications encompassed within the spirit and scope of the present invention, including all equivalent aspects.

It is a claimed

1. a monitor control system used on a vehicle for displaying multiple video signals on a single screen comprising:
at least two cameras for outputting individual video signals;
at least one monitor for receiving video signals outputted by said cameras and for visually displaying said video signals as images on said screen;
and a video image processor connected to each monitor for processing said individual video signals and for processing and combining said individual signals into one standard video signal.

2. The monitor control system according to claim 1 wherein said cameras are mounted at different views on the exterior of said vehicle.

3. The monitor control system according to claim 1 wherein said monitor displays either one selected said individual video signal or selected said combined video signal.

4. The monitor control system according to claim 1 further comprising a controller connected to said video image processor for selecting either an individual video signal or a combined video signal.

5. The monitor control system according to claim 1 further comprising a user interface for selecting either said individual signal or said combined signal to display.

6. A method of displaying multiple images from a camera on one screen comprising the steps of:
generating separate video signals from more than one camera;
converting and amplifying said separate video signals for compatibility with a video image processor;
and combining at least two separate video signals into one single standard video output signal.

7. The method according to claim 6 further comprising selecting said one single standard video output signal for displaying on one screen of a monitor.

8. A monitor control system for a commercial truck with a trailer comprising:
four cameras for generating individual video signals, wherein said cameras are mounted on the exterior of a truck with an attached trailer, at least one video image processor for combining said individual video signals from said cameras, at least one monitor for displaying said individual video signals or said combined video signals connected to said video image processor, and selector for selecting which signals to display on said monitor.

9. The monitor control system according to claim 8 wherein said cameras are mounted on the front of the truck.

10. The monitor control system according to claim 8 wherein said cameras are mounted on the back end of the trailer.

11. The monitor control system according to claim 8 wherein said cameras are mounted on the side view mirror of the truck.

12. The monitor control system according to claim 8 wherein said cameras are mounted on a cab-top of the truck.

13. The monitor control system according to claim 8 further comprising multiple monitors for displaying said individual or combined video signals.

14. The monitor control system according to claim 13 further comprising a video instrumentation amplifier for outputting two amplified signals.

15. The monitor control system according to claim 8 wherein said cameras are wireless.
